(19) United States
(12) Patent Application Publication
(10) Pub. No.: US 2021/0122269 A1
(43) Pub. Date: Apr. 29, 2021

(54) SEAT BELT CLIP FOR CHILD CAR SEATS THAT WILL NOT RETRACT THE SEATBELT DURING INSTALLATION

(71) Applicants: Manuel Garcia, Clifton, NJ (US); Jude A. Russo, Clifton, NJ (US); Diego A. Rivera, Clifton, NJ (US)

(72) Inventors: Manuel Garcia, Clifton, NJ (US); Jude A. Russo, Clifton, NJ (US); Diego A. Rivera, Clifton, NJ (US)

(21) Appl. No.: 16/661,969

(22) Filed: Oct. 23, 2019

(51) Int. Cl. B60N 2/28

(52) U.S. Cl. CPC B60N 2/2806

(57) ABSTRACT

The present invention includes a system to facilitate the installation of a child's car seat, comprising a seat belt clip; wherein the seat belt clip contains teeth on the top and the bottom that are designed to interlock when closed utilizing a ratchet mechanism, thereby holding the seat belt firmly and preventing the seat belt from recoiling; wherein the seat belt clip has a latch that allows the seat belt clip to close securely; and wherein the seat belt clip functions with a child's car seat that is connected to a car using a seat belt, and not using latches.

The present invention also includes a method to facilitate the installation of a child's car seat, comprising: a user uncoiling a seat belt to the maximum extent of the seat belt; wherein the user then holds the seat belt at the maximum extent; wherein the user opens a seat belt clip; wherein the user slides the seat belt clip onto the top of the seat belt from the bottom side of the seat belt, such that the seat belt is flush with the seat belt clip; wherein the user ratchet locks the seat belt clip onto the top of the seat belt; wherein the user then releases the seat belt and installs the car seat; wherein the user then removes the seat belt clip; and wherein the car seat is connected to the car using the seat belt, and not using latches.

### BACKGROUND

Today, the marketplace contains a variety of ways to handle a child sitting in a car, including baby car seats. There are also a wide variety of car seats that can be placed into a car. However, according to a car seat installation expert, 9 out of 10 parents install their car seat incorrectly. Part of this problem is that car seats are difficult and time-consuming to correctly install. There are a variety of solutions to this problem, including strap restraining systems, belt restraining systems, a restraining device for a car seat harness shoulder strap, and even a belt-guiding element for a child protection system.

Unfortunately, these devices do not save time during installation, and in fact many of them appear incredibly complicated. A busy mother or father does not have time for complicated devices, and does not have the time to check whether such devices are properly installed.

### SUMMARY

The present invention includes a seat belt clip that holds the seat belt back while someone installs a child's car seat. The clip prevents recoil from the seat belt, which is helpful because the recoil interferes in the ability to put a child's car seat in the car.

The present invention also prevents someone from injuring their hands and fingers due to the recoil of a seat belt. The present invention potentially eliminates at least 10 minutes from installation of the car seat, as well as eliminating a lot of aggravation.

There are 24 million kids with car seats in the US today, so this is an area in which a lot of people could use help in order to get things done faster.

### BRIEF DESCRIPTION OF THE DRAWINGS

FIG. 1A shows one embodiment of the invention without descriptive lines.

FIG. 1B shows one embodiment of the invention with descriptive lines.

FIG. 2A shows one embodiment of the invention without descriptive lines.

FIG. 2B shows one embodiment of the invention with descriptive lines.

FIG. 3 shows the top side view of the present invention.

FIG. 4 is a bottom side view of the present invention.

FIG. 5 is a front side view of the invention when closed.

FIG. 6 is a rear side view of the invention when closed.

FIG. 7 shows a child car seat wherein the present invention is used.

FIG. 8 shows a small plastic device that helps the user to thread the invention through the car seat.

### DETAILED DESCRIPTION

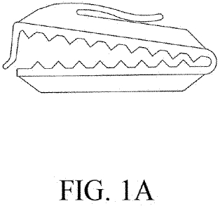

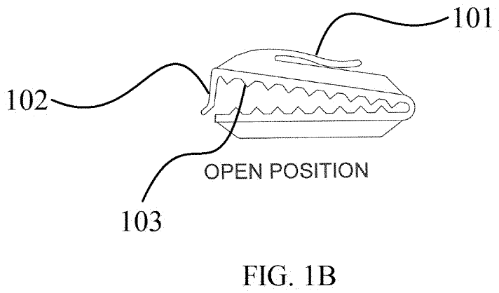

FIG. 1A shows one embodiment of the invention without descriptive lines.

FIG. 1B shows one embodiment of the invention with descriptive lines.

The top clamp 101 is a part by which a human can hold the larger invention, or attach the invention to something else, so that it stays put.

The latch 102 has been designed to use ratchet mechanisms. This allows the latch to easily move in one direction, towards closing, and to not move in the other direction, opening, unless a much higher amount of force is exerted.

The teeth 103 has been designed so as to interlock in a firm grip, holding the seat belt back, and thus preventing recoil and allowing the user to install a child's car seat.

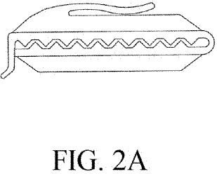

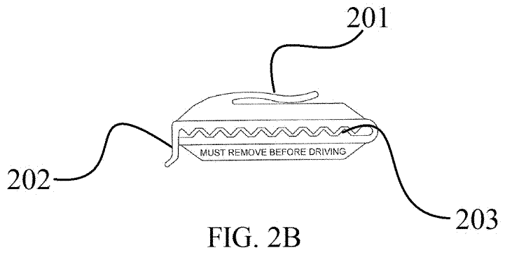

FIG. 2A shows one embodiment of the invention without descriptive lines.

FIG. 2B shows one embodiment of the invention with descriptive lines.

FIG. 2 is a closed version of the present invention. It has a top clamp 201. The latch 202 is closed and is kept closed using the ratchet mechanism. The teeth 203 help to keep the present invention closed, so as to make sure the seat belt does not recoil.

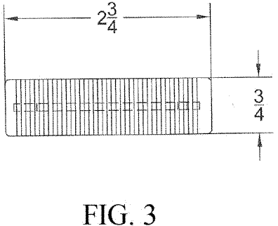

FIG. 3

FIG. 3 shows the top side view of the present invention. Here, the ridges are visible, and are useful in terms of keeping a firm grip on the device when necessary. It also shows that the length of the seat belt clip is 2 and ¾ inches, and the width of the seat belt clip is ¾ inch.

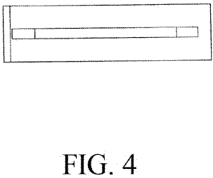

FIG. 4

FIG. 4 is a bottom side view of the present invention.

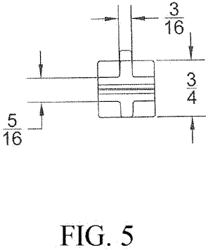

FIG. 5

FIG. 5 is a front side view of the invention when closed. The top clamp, by which a user can attach the seat belt clip to their clothing or belt or something else, is 3/16 inch wide. The seat belt clip itself, excluding the top clamp, is ¾ inch in height. The teeth portion of the seat belt clip is 5/16 inch in height.

The top clamp that allows a user to attach the seat belt clip to their clothes or anything else, is removable, and is not necessarily attached to the invention. The clamp can optionally be used by a user to hold onto the seat belt clip.

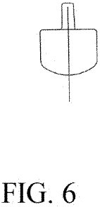

FIG. 6

FIG. 6 is a rear side view of the invention when closed.

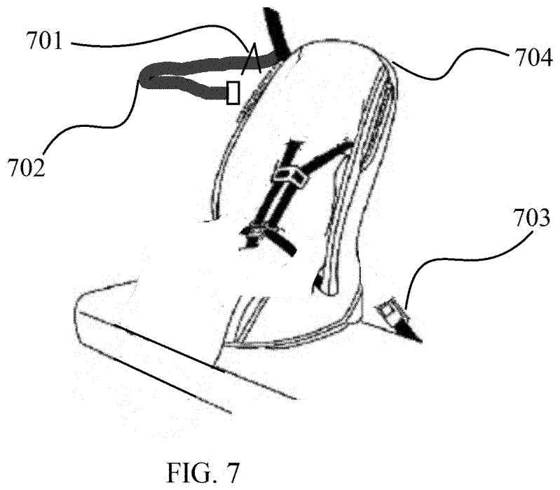

FIG. 7

FIG. 7 shows a child car seat wherein the present invention is used to hold back the seat belt, preventing it from recoiling, and thus giving slack on the seat belt to the user, who can more quickly install the child car seat using the seat belt.

The seat belt clip 701 is in use, and holds back the seat belt 702, shown with plenty of slack. The buckle 703 of the seat belt is on the other side of the child car seat. The child car seat 704 is in the car.

One embodiment of the present invention includes the user uncoiling the seat belt as much as possible and holding the seat belt, then opening the seat belt clip, and then sliding the seat belt clip from underneath onto the top of the seat belt. The seat belt should be flush with the seat belt clip. Then the user should ratchet lock the seat belt clip. Then when the user releases the seat belt, the seat belt will not uncoil, because the seat belt clip will block the uncoiling. This allows for lots of slack in the seat belt, making the installation of the car seat an easier process. This is because the seat belt has been stopped from recoiling.

Then after that the user can install a car seat. In one embodiment of the present invention, the user puts the seat belt through the harness of the car seat. Then the user buckles the seat belt. Then the user tightens the seat belt. Now the user can remove the seat belt clip because the seat belt clip has accomplished its goal of stopping the recoiling of the seat belt during the installation of the car seat.

In another embodiment of the present invention, the user can put some body weight on the installed car seat in order to make sure the car seat is securely installed.

In one embodiment of the present invention, the seat belt clip allows a user to install a car seat in 1 minute and 10 seconds, which is incredibly faster than the time it takes a typical user to install a car seat without the seat belt clip.

One embodiment of the present invention does not utilize latches to connect the child's car seat to the car, it is only for use when using the seat belt to connect the child's car seat to the car.

In one embodiment of the present invention, the seat belt clip is made of plastic. In another embodiment of the present invention, the seat belt clip is made of metal. In another embodiment of the present invention, the seat belt clip is made of wood. In another embodiment of the present invention, the seat belt clip is made of rubber.

The present invention is able to work with child car seats for all ages of children, from newborn to a few years old.

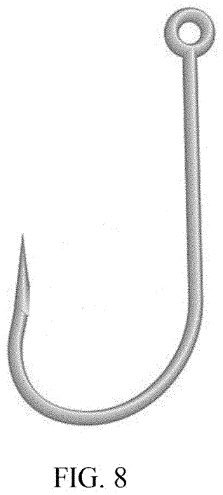

FIG. 8

In addition, another embodiment of the present invention is shown in FIG. 8 and includes a small plastic device. This device helps the user to thread the invention through the car seat. That is, the user can pull down the car seat and lock 3 feet of seat belt. thereby creating some slack on the seat belt so that the seat belt does not retract. Then the user can more easily install the car seat by using the small plastic device to thread the seat belt through the car seat.

This plastic device has a plastic hook that goes around the metal plate of the seat belt, and then the user uses the plastic hook to thread the seat belt through the back of the car seat. This plastic device can be added to the main device of the present invention. The little hook goes into a hole, so now there is a long piece of metal that the user can reach and grab. This further accelerates the process of installation of the child's car seat.

In another embodiment of the invention, a neon light is attached to the seat belt clip, wherein the neon light turns on when the seat belt clip is squeezed closed, and the neon light turns off when the seat belt clip is opened. This serves as a reminder to the user that the seat belt clip is on, so that they remember to take it off when necessary.

A system to facilitate the installation of a child's car seat, comprising: a seat belt clip; wherein the seat belt, clip contains teeth on the top and the bottom that are designed to interlock when closed utilizing a ratchet mechanism, thereby holding a seat belt firmly and preventing the seat belt from recoiling; wherein the seat belt clip has a latch that allows the seat belt clip to close securely; wherein the seat belt clip functions with a child's car seat that is connected to a car using a seat belt, and not using latches.

The system further comprising: wherein the seat belt clip is made of plastic.

The system further comprising: wherein the seat belt clip is made of metal.

The system further comprising: wherein the seat belt clip is made of wood.

The system further comprising: wherein the seat belt clip is made of rubber.

The system further comprising: wherein a small plastic device helps the user to thread the invention through the car seat; wherein the small plastic device is a plastic tie around the metal plate of the seat belt, and it goes through the back of the car seat; wherein the plastic device has a little hook that attaches to the metal piece of the seat belt; wherein the little hook goes into a hole of the seat belt, so now there is a long piece of metal that the user can reach and grab.

The system further comprising: wherein a small plastic device helps a user to thread the invention through the car seat; wherein the small plastic device has a plastic hook that hooks onto the metal plate of the seat belt, such that the user can thread the seat belt through the back of the car seat; wherein the little hook goes into a hole of the seat belt, so now there is a long piece of metal that the user can reach and grab so as to more easily install the car seat.

The system further comprising: wherein a neon light attached to the seat belt clip, wherein the neon light turns on when the seat belt clip is squeezed closed, and the neon light turns off when the seat belt clip is opened.

A method to facilitate the installation of a child's car seat, comprising: a user uncoiling a seat belt to the maximum extent of the seat belt; wherein the user then holding the seat belt at the maximum extent; wherein the user opening a seat belt clip; wherein the user sliding the seat belt clip onto the top of the seat belt from the bottom side of the seat belt, such that the seat belt is flush with the seat belt clip; wherein the user ratchet locking the seat belt clip onto the top of the seat belt; wherein the user then releasing the seat belt and installing the car seat; wherein the user then removing the seat belt clip; wherein the car seat is connected to the car using the seat belt, and not using latches.

The method further comprising: wherein the seat belt clip is made of plastic.

The method further comprising: wherein the seat belt clip is made of metal.

The method further comprising: wherein the seat belt clip is made of wood.

The method further comprising: wherein a small plastic device helps the user to thread the invention through the car seat; wherein the small plastic device is a plastic tie around the metal plate of the seat belt, and it goes through the back of the car seat; wherein the small plastic device has a little hook that attaches to the metal piece of the seat belt; wherein the little hook goes into a hole of the seat belt, so now there is a long piece of metal that the user can reach and grab.

The method further comprising: wherein a small plastic device helps a user to thread the invention through the car seat; wherein the small plastic device has a plastic hook that hooks onto the metal plate of the seat belt, such that the user can thread the seat belt through the back of the car seat; wherein the little hook goes into a hole of the seat belt, so now there is a long piece of metal that the user can reach and grab so as to more easily install the car seat.

The method further comprising: wherein a neon light attached to the seat belt clip, wherein the neon light turns on when the seat belt clip is squeezed closed, and the neon light turns off when the seat belt clip is opened.

A system to facilitate the installation of a child's car seat, comprising: a seat belt clip; wherein the seat belt clip contains teeth on the top and the bottom that are designed to interlock when closed utilizing a ratchet mechanism, thereby holding a seat belt firmly and preventing the seat belt from recoiling; wherein the seat belt clip has a latch that allows the seat belt clip to close securely; wherein the seat belt clip functions with a child's car seat that is connected to a car using a seat belt. and not using latches; wherein the seat belt clip can be made of either plastic, metal or wood; wherein a small plastic device helps the user to thread the invention through the car seat; wherein the small plastic device is a plastic tie around the metal plate of the seat belt, and it goes through the back of the car seat; wherein the plastic device has a little hook that attaches to the metal piece of the seat belt; wherein the little hook goes into a hole of the seat belt, so now there is a long piece of metal that the user can reach and grab.

A system to facilitate the installation of a child's car seat, comprising: a seat belt clip; wherein the seat belt clip contains teeth on the top and the bottom that are designed to interlock when closed utilizing a ratchet mechanism, thereby holding a seat belt firmly and preventing the seat belt from recoiling; wherein the seat belt clip has a latch that allows the seat belt clip to close securely; wherein the seat belt clip functions with a child's car seat that is connected to a car using a seat belt, and not using latches; wherein the seat belt clip can be made of either plastic, metal or wood; wherein a small plastic device helps a user to thread the invention through the car seat; wherein the small plastic device has a plastic hook that hooks onto the metal plate of the seat belt, such that the user can thread the seat belt through the back of the car seat; wherein the little hook goes into a hole of the seat belt, so now there is a long piece of metal that the user can reach and grab so as to more easily install the car seat; wherein a neon light attached to the seat belt clip, wherein the neon light turns on when the seat belt clip is squeezed closed, and the neon light turns off when the seat belt clip is opened; wherein the seat belt clip can be of any size in length, any size in width, as long as it is slightly larger than a seat belt for which it's supposed to be locked into place; wherein the clamp part that allows a user to attach the seat belt clip to their clothes or anything else, is removable, and is not necessarily attached to the invention: so the clamp can optionally be used by a user to hold onto the seat belt clip.

Having described the invention by the description and illustrations above, it should be understood that these are exemplary of the invention and are not to be considered as limiting. Accordingly, the invention is not to be considered as limited by the foregoing description, but includes any equivalents.

1. A system to facilitate the installation of a child's car seat, comprising:
a seat belt clip;
wherein the seat belt clip contains teeth on the top and the bottom that are designed to interlock when closed utilizing a ratchet mechanism, thereby holding a seat belt firmly and preventing the seat belt from recoiling;
wherein the seat belt clip has a latch that allows the seat belt clip to close securely;
wherein the seat belt clip functions with a child's car seat that is connected to a car using a seat belt, and not using latches.

2. The system of claim 1, further comprising:
wherein the seat belt clip is made of plastic.

3. The system of claim 1, further comprising:
wherein the seat belt clip is made of metal.

4. The system of claim 1, further comprising:
wherein the seat belt clip is made of wood.

5. The system of claim 1, further comprising:
wherein the seat belt clip is made of rubber.

6. The system of claim 1, further comprising:
wherein a small plastic device helps a user to thread the invention through the car seat;
wherein the small plastic device has a plastic hook that hooks onto the metal plate of the seat belt, such that the user can thread the seat belt through the back of the car seat;
wherein the little hook goes into a hole of the seat belt, so now there is a long piece of metal that the user can reach and grab so as to more easily install the car seat.

7. The system of claim 1, further comprising:
wherein a neon light is attached to the seat belt clip, wherein the neon light turns on when the seat belt clip is squeezed closed, and the neon light turns off when the seat belt clip is opened.

8. The system of claim 1, further comprising:
wherein the length of the seat belt clip is 2 and ¾ inches;
wherein the width of the seat belt clip is ¾ inches;
wherein a removable top clamp on the top of the seat belt clip is 3/16 inches wide;
wherein the seat belt clip. excluding the top clamp, is ¾ inch in height:
wherein the teeth of the seat belt clip is 5/16 inch in height.

9. The system of claim 1, further comprising:
wherein the seat belt clip can be made of either plastic, metal, wood or rubber;
wherein a small plastic device helps a user to thread the invention through the car seat;
wherein the small plastic device has a plastic hook that hooks onto the metal plate of the seat belt, such that the user can thread the seat belt through the back of the car seat;
wherein the little hook goes into a hole of the seat belt, so now there is a long piece of metal that the user can reach and grab so as to more easily install the car seat;
wherein a neon light is attached to the seat belt clip, wherein the neon light turns on when the seat belt clip is squeezed closed, and the neon light turns off when the seat belt clip is opened;
wherein the length of the seat belt clip is 2 and ¾ inches;
wherein the width of the seat belt clip is ¾ inches;
wherein a removable top clamp on the top of the seat belt clip is 3/16 inches wide;
wherein the seat belt clip, excluding the top clamp, is ¾ inch in height;
wherein the teeth of the seat belt clip is 5/16 inch in height.

10. A method to facilitate the installation of a child's car seat, comprising:
a user uncoiling a seat belt to the maximum extent of the seat belt;
wherein the user then holding the seat belt at the maximum extent;
wherein the user opening a seat belt clip;
wherein the user sliding the seat belt clip onto the top of the seat belt from the bottom side of the seat belt, such that the seat belt is flush with the seat belt clip;
wherein the user ratchet locking the seat belt clip onto the top of the seat belt;
wherein the user then releasing the seat belt and installing the car seat;
wherein the user then removing the seat belt clip;
wherein the car seat is connected to the car using the seat belt, and not using latches.

11. The method of claim 10, further comprising:
Wherein the seat belt clip is made of plastic.

12. The method of claim 10, further comprising:
Wherein the seat belt clip is made of metal.

13. The method of claim 10, further comprising:
wherein the seat belt clip is made of wood.

14. The method of claim 10, further comprising:
wherein the seat belt clip is made of rubber.

15. The method of claim 10, further comprising:
wherein a small plastic device helps a user to thread the invention through the car seat;
wherein the small plastic device has a plastic hook that hooks onto the metal plate of the seat belt, such that the user can thread the seat belt through the back of the car seat;
wherein the little hook goes into a hole of the seat belt, so now there is a long piece of metal that the user can reach and grab so as to more easily install the car seat.

16. The method of claim 10, further comprising:
wherein a neon light is attached to the seat belt clip, wherein the neon light turns on when the seat belt clip is squeezed closed, and the neon light turns off when the seat belt clip is opened.

17. The method of claim 10, further comprising:
wherein the length of the seat belt clip is 2 and ¾ inches;
wherein the width of the seat belt clip is ¾ inches;
wherein a removable top clamp on the top of the seat belt clip is 3/16 inches wide;
wherein the seat belt clip, excluding the top clamp, is ¾ inch in height;
wherein the teeth of the seat belt clip is 5/16 inch in height.

18. The method of claim 10, further comprising:
wherein the seat belt clip can be made of either plastic, metal, wood or rubber;
wherein a small plastic device helps a user to thread the invention through the car seat;
wherein the small plastic device has a plastic hook that hooks onto the metal plate of the seat belt, such that the user can thread the seat belt through the back of the car seat;
wherein the little hook goes into a hole of the seat belt, so now there is a long piece of metal that the user can reach and grab so as to more easily install the car seat;
wherein a neon light is attached to the seat belt clip, wherein the neon light turns on when the seat belt clip is squeezed closed, and the neon light turns off when the seat belt clip is opened;
wherein the length of the seat belt clip is 2 and ¾ inches;
wherein the width of the seat belt clip is ¾ inches;
wherein a removable top clamp on the top of the seat belt clip is 3/16 inches wide;
wherein the seat belt clip, excluding the top clamp, is ¾ inch in height
wherein the teeth of the seat belt clip is 5/16 inch in height.

19. A system to facilitate the installation of a child's car seat, comprising:
a seat belt clip;
wherein the seat belt clip contains teeth on the top and the bottom that are designed to interlock when closed utilizing a ratchet mechanism, thereby holding a seat belt firmly and preventing the seat belt from recoiling;
wherein the seat belt clip has a latch that allows the seat belt clip to close securely;
wherein the seat belt clip functions with a child's car seat that is connected to a car using a seat belt, and not using latches;
wherein the seat belt clip can be made of either plastic, metal, wood or rubber;
wherein a small plastic device helps a user to thread the invention through the car seat;
wherein the small plastic device has a plastic hook that hooks onto the metal plate of the seat belt, such that the user can thread the seat belt through the back of the car seat;
wherein the little hook goes into a hole of the seat belt, so now there is a long piece of metal that the user can reach and grab so as to more easily install the car seat;
wherein a neon light is attached to the seat belt clip, wherein the neon light turns on when the seat belt clip is squeezed closed, and the neon light turns off when the seat belt clip is opened;
wherein the length of the seat belt clip is 2 and ¾ inches;
wherein the width of the seat belt clip is ¾ inches;
wherein a removable top clamp on the top of the seat belt clip is 3/16 inches wide;
wherein the seat belt clip, excluding the top clamp, is ¾ inch in height;
wherein the teeth of the seat belt clip is 5/16 inch in height.
